(19) United States
(12) Patent Application Publication
(10) Pub. No.: US 2007/0070499 A1
(43) Pub. Date: Mar. 29, 2007

(54) Optical characteristic

(76) Inventors: Peter James Fricke, Corvallis, OR (US); Timothy Emmerich, Corvallis, OR (US); Marshall Field, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/235,995

(22) Filed: Sep. 26, 2005

(51) Int. Cl. G09G 5/00; G03B 21/56

(52) U.S. Cl. 359/443; 345/204

(57) ABSTRACT

Embodiments of changing an optical characteristic are disclosed.

### BACKGROUND

Typical front projection systems may provide images that are less desirable than those provided by other projection systems. For example, when a front projection system is used in an environment with ambient light (such as a bright room), projected images may be displayed with an undesirably low contrast. Hence, current front projection implementations may provide unacceptable images when used in the presence of ambient light.

### BRIEF DESCRIPTION OF DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates an example of a cross sectional block diagram of an embodiment of a front projection system, according to an embodiment.

FIG. 2 illustrates an example of a front view of an embodiment of a screen, according to an embodiment.

FIG. 3 illustrates an example of a rear view of an embodiment of a screen, according to an embodiment.

FIG. 4 illustrates an example of a cross sectional view of an embodiment of a portion of a screen, according to an embodiment.

FIG. 5 illustrates an example of an embodiment of a screen, according to an embodiment.

FIG. 6 illustrates an example of an embodiment of a pad segment circuit, according to an embodiment.

FIG. 7 illustrates an example of an embodiment of a method, according to an embodiment.

FIGS. 8A and 8B illustrate examples of embodiments of screen modules that may be coupled to form a larger screen, according to various embodiments.

### DETAILED DESCRIPTION

Embodiments discussed herein may provide a projection screen that achieves relatively high refresh response with a direct drive segmented screen configuration, e.g., that enables relatively large display sizes with a simple, inexpensive, and/or low voltage drive system. The plurality of segments, such as pad segments, may be individually replaced and/or repaired to increase the production yield. In an embodiment, one or more microcontrollers may be coupled to the pad segments (e.g., via traces) to electrically drive the pad segments. Driving the pad segments independently may modify a characteristic of the whole screen, such as an optical characteristic (e.g., screen reflectivity or absorbance).

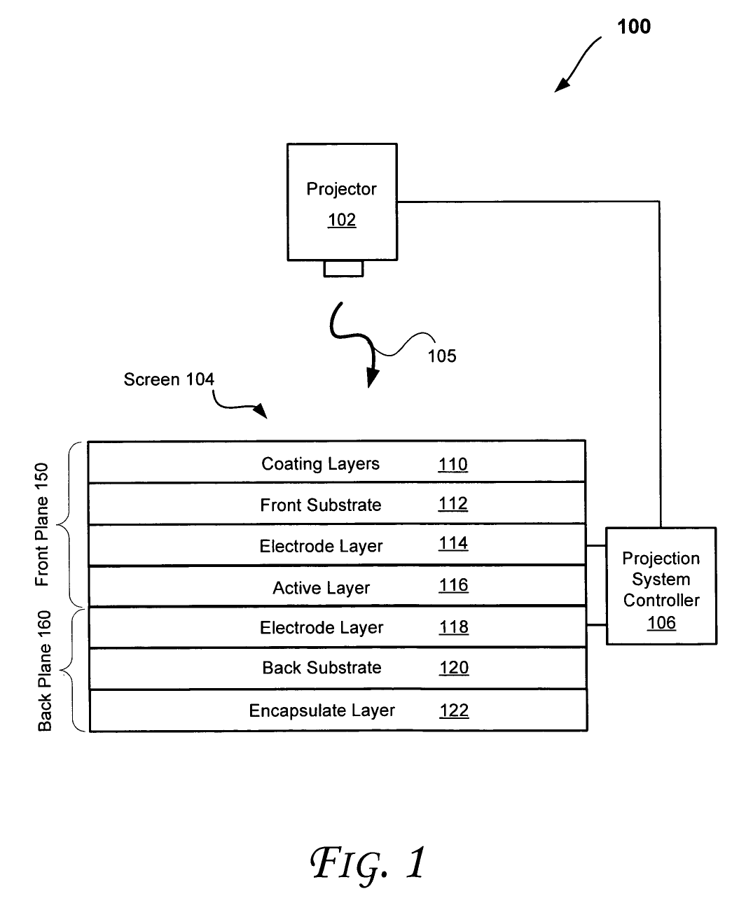

FIG. 1 illustrates a cross sectional block diagram of an embodiment of a front projection system 100, according to an embodiment. The front projection system 100 includes a projector 102 to project images on an embodiment of a screen, such as a screen 104. The projector 102 may provide visible and/or non-visible light (105) as will be further discussed herein. The screen 104 may be a suitable projection screen such as a rear projection screen or a front projection screen. As illustrated in FIG. 1, the screen 104 (and, in some embodiments, the projector 102) may be coupled to a projection system controller 106. The projection system controller 106 may coordinate the operation of the projector 102 and the screen 104. Also, the projection system controller 106 may control the reset of the screen 104 (e.g., when difficulties are encountered with timing, image projection, and the like), provide and/or condition a power supply (e.g., providing electrical power to the screen 104), and/or establish the timing of the reset. The projector 102 may be any suitable digital projector such as a liquid crystal display (LCD) projector, a digital light processing (DLP) projector, and the like. Moreover, even though FIG. 1 illustrates a front projection system (100), the techniques discussed herein may be applied to a rear projection system (where the transmissiveness of the screen may be modified).

The screen 104 may be a projection screen with a modifiable optical characteristic, e.g., that is capable of assuming multiple reflectivity and/or absorbance states. The multiple reflectivity and/or absorbance states may provide a higher contrast ratio in the presence of ambient light and/or a color projected on the screen 104 by the projector 102, than would otherwise be obtained, as is further discussed herein.

As illustrated in FIG. 1, the screen 104 may include one or more coating layers 110, a front substrate 112, an electrode layer 114, an active layer 116, an electrode layer 118, a back substrate 120, and an encapsulate layer 122. The coating layers 110 may be one or more layers deposited on the front substrate 112 that may include an antireflective layer such as a suitable anti-glare surface treatment, an ambient rejection layer such as a plurality of optical band pass filters, one or more micro-lenses, and/or a diffuse layer. The front substrate 112 may be an optically clear and flexible material such as Polyethylene Terephthalate (PET or PETE) on which the coating layers 110 are formed. The electrode layer 114 may be formed on the bottom surface of the front substrate 112.

The electrode layer 114 may be one or more suitable transparent conductors such as Indium Tin Oxide (ITO) or Polyethylene Dioxythiophene (PEDOT). In one embodiment, the electrode layer 114 may form the top conductor(s) of the active layer 116.

The active layer 116 may be an optically and/or electrically active layer that responds to the application of light or voltage across itself with a change in its absorbance and/or reflectivity. A number of different active layers 116 may provide such a response. One example includes a polymer dispersed liquid crystal (PDLC) layer in which pockets of liquid crystal material are dispersed throughout a transparent polymer layer. In an embodiment, the active layer 116 may be a continuous dichroic-doped PDLC layer that appears white (or black) in color under a no voltage condition. In an embodiment, an optical sensor may be used to sense non-visible light from the projector 102 and signal the active layer 116 to activate and/or change states. The optical sensor may be located at any suitable location to receive the light from the projector 102, such as around the periphery of the screen 104. As illustrated in FIG. 1, the projector 102 may be coupled to the projection system controller 106 via a wire, e.g., to signal the active layer 116 to activate and/or change states, and/or wirelessly.

In some embodiments, a chemical coating or thin film layer of electrochromic material, such as Tungsten Oxide, or photochromic material, across which an electric field may be selectively applied, may serve as the active layer 116 and may be made photosensitive. The application of a bias across such an electrochromic material active layer (116) (or the addition of the appropriate wavelength of light to the active layer 116 that is light sensitive) may enable the screen 104 to switch from white to gray or white to clear, in which case a gray or black backer may be included. Such an embodiment may include an ITO array type of conductive layer 114 on the front or top of the screen 104 and a second conductive layer (118) on the opposite side of the active layer near the back layer. The optical response of the screen (104) may be related to the amount of non-visible light hitting the optically active area of the screen (104).

In an embodiment, the electrode layer 118 may be similar to the electrode layer 114 and be positioned on the back substrate 120. An opposite charge may be applied to the electrode layer 118 (e.g., relative to the charge applied to the electrode layer 114). Similarly, the back substrate 120 may be similar to the front substrate 112 in material composition but different in its position at the bottom of the stack of the screen 104, and its relatively darker color (or white if the active material is black in the non-energized state). In one embodiment, the projection system controller 106 selectively applies a voltage across the active layer 116 via the application of opposite charges to the electrode layers 114 and 118. Furthermore, the back substrate 120 (and other portions of the screen 104) may be encapsulated by a protective layer such as the encapsulate layer 122. The selective application of the voltage across the active layer 116 may enable the adjustment of the optical characteristic of the screen (104) over time and/or for a plurality of sections of the screen (104).

In an embodiment, light (105) is projected from the projector 102 and impinges upon the screen 104. The coating layers 110 may reduce specular reflection both in the visible and non-visible range from the screen 104 by implementing an antireflection coating. The coating layers 110 may also serve to absorb and/or deflect a portion of the ambient light that may be generated by extraneous sources other than the projector 102, e.g., by implementing an ambient rejection coating. The coating layers 110 allow a portion of the light incident upon its surface to pass through (partially diffuse) to the layers underlying the coating layers 110.

In one embodiment of front projection system 100, the active layer 116 is a continuous optically active material that is capable of assuming multiple states of reflectivity (or absorbance). Upon receiving an appropriate optical signal, the active layer 116, or a portion thereof (such as one or more pixels), switches between at least two states of reflectivity (or absorbance). With the inclusion of a black layer below active layer 116 (e.g., coated atop electrode layer 118, below electrode layer 118, or atop back substrate 120), the stacked configuration of the projection screen 110 provides a display that may change from off white (or milky white) to black, including intermediate grayscale states.

In an embodiment, the screen 104 may include white and clear modes, where clear mode provides a view of the black/dark back layer (e.g., 120). Alternatively, the screen 104 may include black and clear modes, e.g., the active layer (116) is dyed black or dark gray for absorbance purposes. In this case, a highly reflective back layer (120) may be utilized, rather than a black layer.

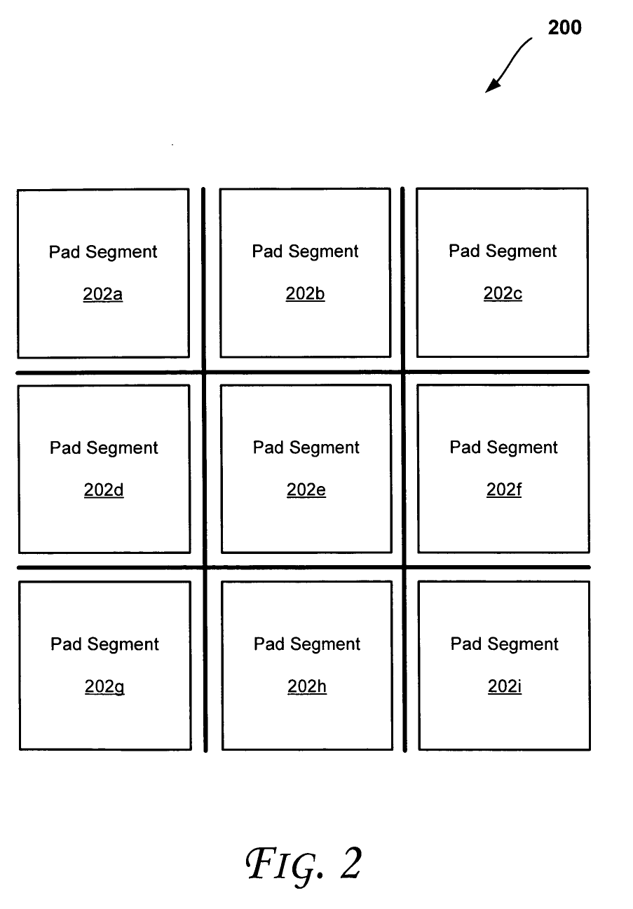

As illustrated in FIG. 1, the layers 110-116 may form a front plane 150. The layers 118-122 may form a back plane 160. In some embodiments, the back plane 160 may have a plurality of pad segments (such as discussed with reference to FIGS. 2-4), e.g., to increase the refresh rate of the screen 104. Also, such a front projection system (100) may provide enhanced image contrast by changing the reflectance and/or absorbance of the screen 104, e.g., in coordination with projected image modification by the projection system controller 106 and/or the ambient light (105). The front projection system 100 therefore may provide relatively deeper blacks by changing the color of the screen (104) from white to black. Under ambient light conditions, such a system (100) may produce a contrast ratio that may be the multiplicative product of the inherent contrast ratio of the projector 104 and the contrast change made by the screen 104.

FIG. 2 illustrates an example of a front view of an embodiment of a screen 200. The screen 200 includes nine elements that include pad segments 202a through 202i, which may be electrically conductive pad segments. As previously explained, the elements have the capability to change reflectance (or absorbance) according to a voltage applied across the active layer of the element. In one embodiment, the pad segments similar to pad segments (202) may be used for the screen 104 of FIG. 1. For example, the pad segments (202) may be individual pad segments that are joined to form the screen 104. Also, the pad segments (202) may be patterned (e.g., etched) on the back substrate 120 (e.g., on the electrode layer 118 of FIG. 1). The pad segments 202 may also be pad segments of the screen 104, e.g., that comprise the substrate (120) and/or electrode (118) layers.

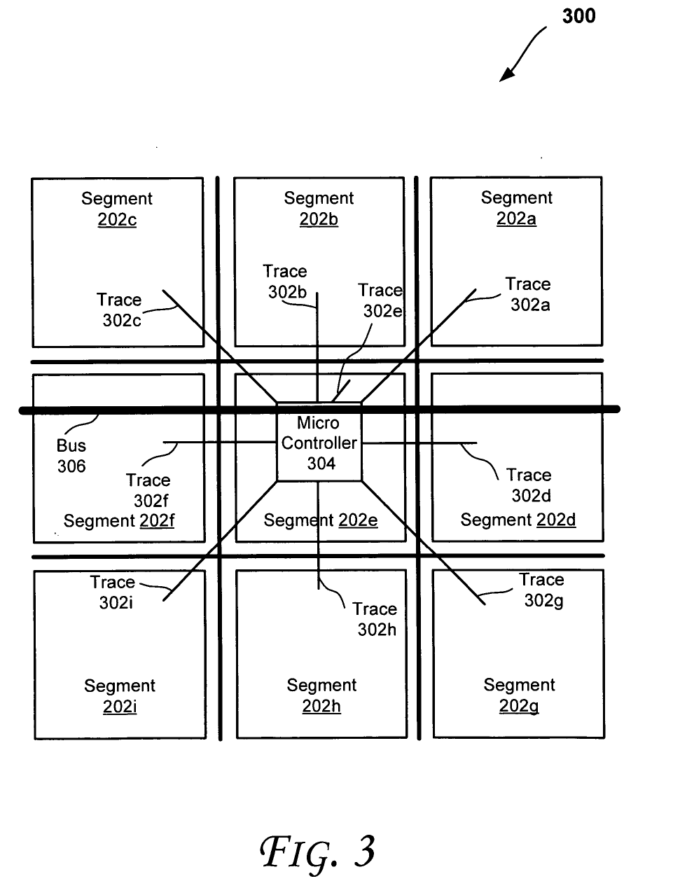

FIG. 3 illustrates an example of a rear view of an embodiment of a screen 300. In an embodiment, the screen 300 may be the same or similar to the screen 104 of FIG. 1. The screen 300 includes nine traces 302a through 302i, one or more microcontrollers 304, a bus 306 may be included in some embodiments (e.g., to provide a communication channel between the microcontroller(s) 304 and the system controller 106 of FIG. 1, and the pad segments 202a through 202i). The traces 302 may be any suitable type of an electrical connector (e.g., an electrically conductive wire) that is constructed by using suitable material such as aluminum, copper, carbon, combination (or alloys) thereof, or the like. Furthermore, instead of or in addition to the bus 306, a wireless connection (not shown) may be utilized to establish a communication channel between the microcontroller(s) 304 and the system controller 106 of FIG. 1. Moreover, the bus 306 may also be a connection to a source of power and may connect multiple screen sections, as when the pad segments forming screen 300 are repeated and a very large sectioned screen is formed.

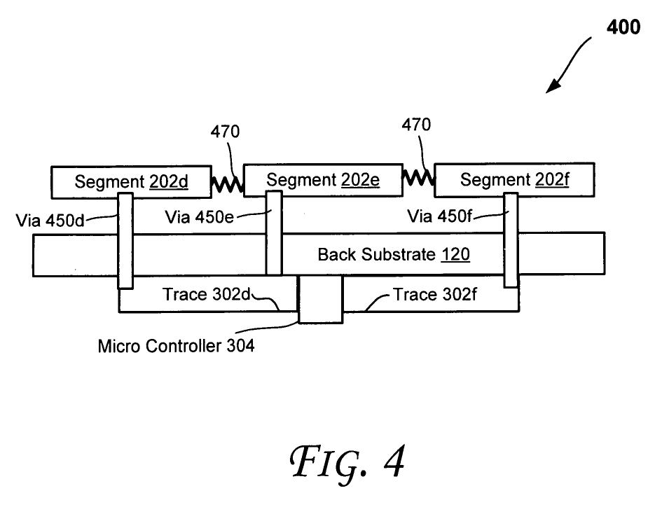

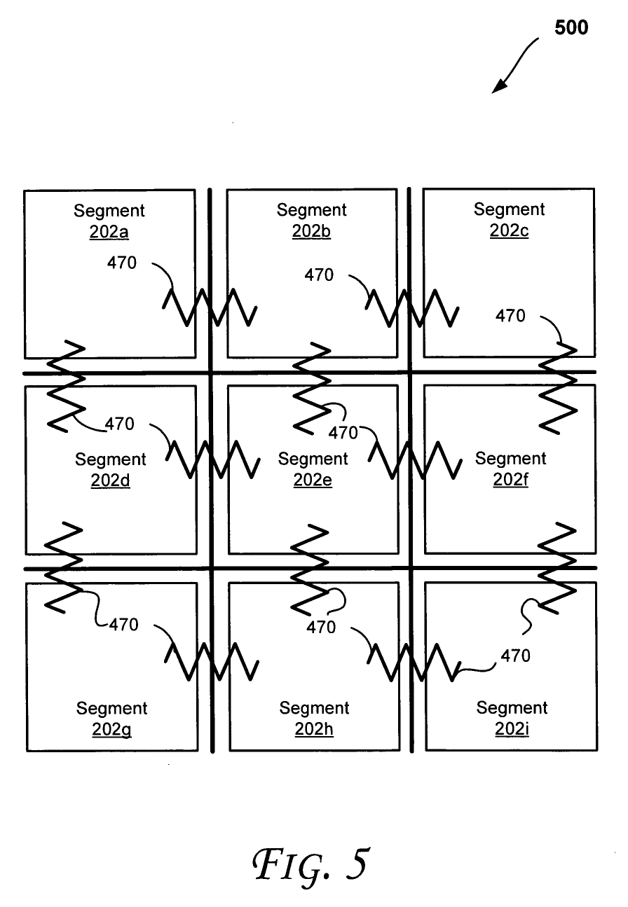

FIG. 4 illustrates an example of a cross sectional view of an embodiment of a portion of a screen 400. In an embodiment, the screen 400 may be the same or similar to a portion (e.g., a portion of the electrode layer 118 and the back substrate 120) of the screen 104 of FIG. 1. The screen 400 includes pad segments 202d, 202e, and 202f; back substrate 120; two traces 302d and 302f; microcontroller 304; and three vias 450d, 450e, and 450f (e.g., to electrically couple the pad segments 202 to traces 302). For example, via 450d couples the pad segment 202d to the trace 302d and the via 450f couples the pad segment 202f to the trace 302f. The trace (302e) that would couple the pad segment 202e to the trace 302e is not shown in FIG. 4 for clarity. The vias 450 may be any suitable vias or electrical connectors to establish an electrical connection between the traces 302 and the pad segments 202 through the back substrate 120. Material such as those discussed with reference to the traces 302 may be utilized to construct the vias 450. In some embodiments the screen 400 may additionally include the resistors 470 that may couple the adjacent pad segments (e.g., 202e and 202d, and 202e and 202f) as will be further discussed with reference to FIG. 5.

FIG. 5 illustrates an example of an embodiment of a screen 500. In one embodiment, the screen 500 is an alternate configuration of the screen 104 of FIG. 1. In some embodiments, the screen 500 may also include one or more resistors 470 between the pad segments 202a through 202i. The resistors 470 may have the same resistance value, or different values depending on the implementation. Moreover, the value of the resistors 470 may be selected to maintain pad segments 202a through 202i at the same or substantially the same voltage level. Also, the inclusion of resistors 470 between adjacent pad segments 202 may further enable the adequate charging of defective pixels formed by the pad segments 202, e.g., to increase the production yield of the screen 500.

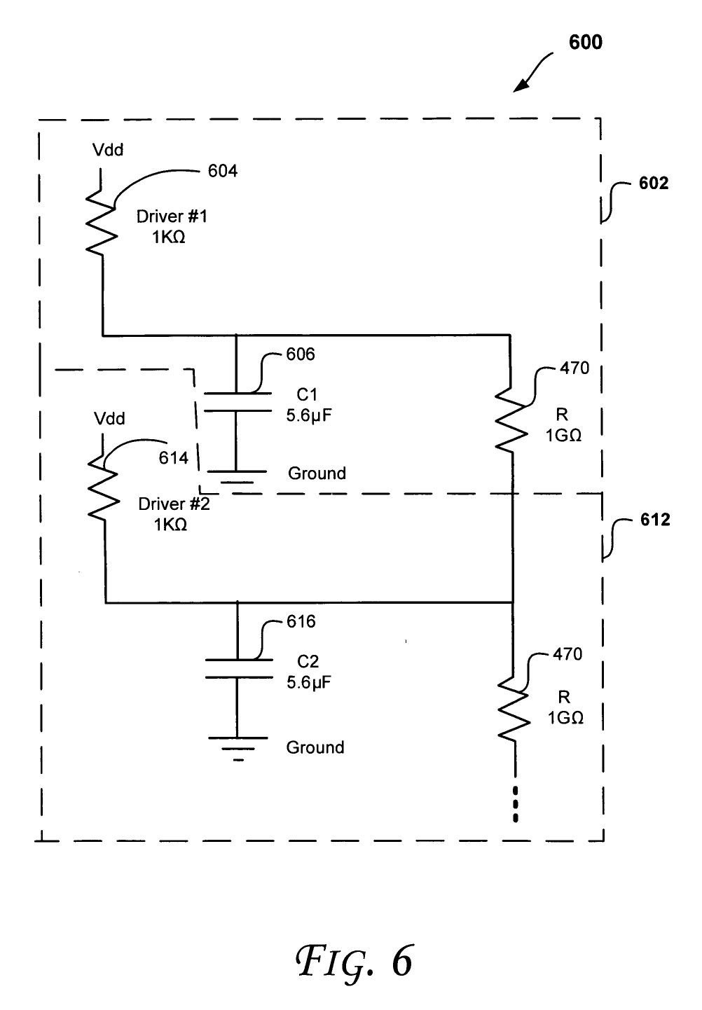

FIG. 6 illustrates an example of an embodiment of a pad segment circuit 600. The circuit 600 may represent an equivalent circuit for two of the pad segments 202a through 202i, discussed with reference to FIGS. 1-5. For example, circuit 602 may represent an equivalent circuit for a single pad segment having a driver 604, resistor 470 (e.g., as discussed with reference to FIGS. 4-5), and a capacitor 606. Similarly, circuit 612 may represent an equivalent circuit for a different pad segment having a driver 614, resistor 470 (e.g., as discussed with reference to FIGS. 4-5), and a capacitor 616. In one embodiment, a very similar pad segment circuit (e.g., 602 and/or 612) may be associated with each pad segment 202. Moreover, nine very similar pad segment circuits (e.g., 602 and/or 612) may be arranged electrically in parallel to provide the nine pad segments 202a through 202i that form the screen 104 of FIG. 1.

The values shown for the resisters are merely exemplary and any suitable value may be present depending on the implementation. Table 1 below illustrates sample calculated and measured values for pad segment area (A), capacitances (e.g., for capacitors 606 and 616) (Cap), resistances of the electrode layer 114 of FIG. 1, and refresh rate (R (layer 114), Hz), lengths for the sides of each pad segment (x,y), and areas in English units (Feet), assuming a 20 μm the active layer 116 of FIG. 1.

TABLE 1
Sample Area, C, Refresh Rate, Side Lengths, and Screen size

| | | | | R (Layer 114), | | | |
|---|---|---|---|---|---|---|---|
| A | | Cap | | Hz | x, y | | Feet |
| 13.4 | m² | 47.5 | μF | 100 Ω, 21 Hz | 3.66 | m | 12′ × 12′; 16′ × 9′ |
| 1.34 | m² | 4.75 | μF | 100 Ω, 210 Hz | 1.16 | m | 3.8′ × 3.8′; 5.1′ × 2.8′ |
| 0.134 | m² | 0.475 | μF | 100 Ω, 2 kHz | 0.366 | m | 1.2′ × 1.2′; 1.6′ × 0.9′ |
| 0.0134 | m² | 0.0475 | μF | 100 Ω, 20 kHz | 0.116 | m | 0.38′ × 0.38′; 0.51′ × 0.28′ |
| 0.00134 | m² | 4.75 | nF | 100 Ω, 200 kHz | 0.0366 | m | 0.12′ × 0.12′; 0.16′ × 0.09′ |
| 0.000134 | m² | 475 | pF | 100 Ω, 2 MHz | 0.0116 | m | 0.038′ × 0.038′; |
| | | | | | | | 0.051′ × 0.028′ |
| 0.0000134 | m² | 47.5 | pF | 100 Ω, 20 MHz | 3.66 | mm | 0.012′ × 0.012′; |
| | | | | | | | 0.016′ × 0.009′ |
| 1.34 × 10⁻⁶ | m² | 4.75 | pF | 100 Ω, 200 MHz | 1.16 | mm | 0.004′ × 0.004′; |
| | | | | | | | 0.005′ × 0.005′ |

As can be seen from the table above, the configuration of a large tiled or sectioned screen (104) (such as discussed with reference to FIGS. 1-6), e.g., whose optical characteristic is modifiable as a single pixel, enables refresh rates up to and including video rates (e.g., about 50 to 60 Hz) due to the partitioned pad segments 202 that reduce capacitive charging and discharging. For example, a 16′×9′ active screen with a 20 μm active layer (116) has a total capacitance of approximately 50 pF that, assuming a 1000Ω electrode layer 118, has a maximum refresh rate of approximately 2 Hz due to resistor-capacitor (RC) (or delay) constraints. A sectioned screen 104 with a partition of nine 5.3′×3′ pad segments 202 will each have approximately 5.6 μF capacitance and a maximum refresh rate of approximately 18 kHz. The appropriate partitioning of 30 pad segments can support 60 kHz video refresh rate.

In one embodiment, screen 104 could be configured to have an optical characteristic modifiable as a single pixel by synchronizing control of the optical characteristics of the individual elements forming an active area of screen 104. This synchronization could be implemented by a controller, such as one or more microcontrollers in one embodiment, configured so that the optical characteristics (such as, reflectance or absorbance) of the elements are changed substantially in unison (that is, at least close enough in time to achieve a desired or acceptable performance to a viewer) between different levels of the optical characteristic using signals provided by the controller. For example, the controller could be configured to provide signals to the elements forming the active area to change a value of the optical characteristic, such as reflectivity, of the elements from a first value, such as a relatively low reflectivity, to a second value, such as a higher reflectivity. While the controller provides these signals in an attempt to change the value of the optical characteristic from the first value to the second value, it is expected that there will be some variation in the actual value of the optical characteristic achieved by elements between the elements that will still provide acceptable performance to a viewer. Therefore, reference to changing the optical characteristic of the elements from the first value to the second value is inclusive of this expected variation. By operating screen 104 in this manner, the screen 104 could be configured to be controlled as a single element and have the capability to be refreshed at a rate that will provide at least acceptable performance for a viewer.

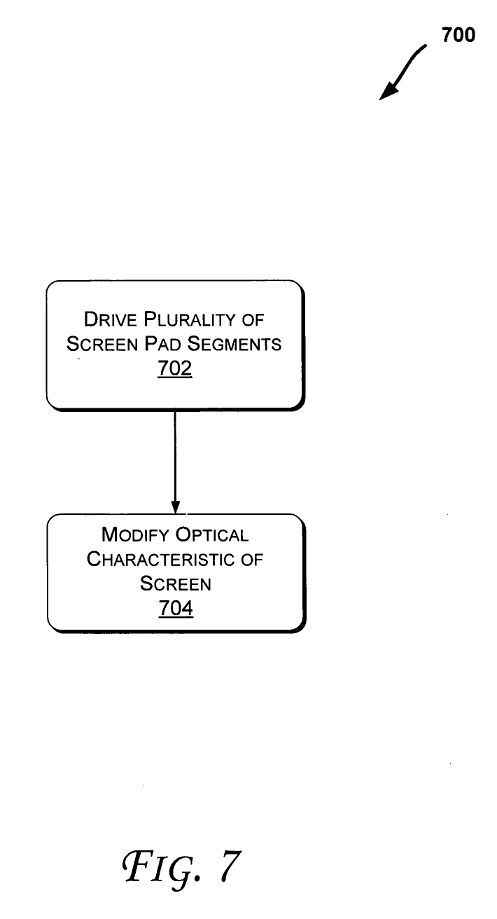

FIG. 7 illustrates an example of an embodiment of a method 700. Referring to FIGS. 1-7, a plurality of electrodes (e.g., the electrode layer 118) may define pad segments 202a through 202i and partition screen 104 into multiple sections whose reflectivity (or absorbance) response is capable of being independently controlled (although it should be recognized that in some embodiments the multiple sections are controlled in a coordinated fashion to have similar reflectivity or absorbance during time intervals) by microcontroller 304. Microcontroller 304 applies a driving voltage to each pad segment 202 (702), and thus a changing potential develops between electrode layer 114 and each pad segment 202 and across the corresponding area of active layer 116. This in turn modifies the optical characteristic (e.g., absorbance or reflectivity) of the screen 104.

Each pad segment 202a through 202i may have a single direct connection to the microcontroller 304 through one of the traces 302. The formation of a sectioned screen 104 allows for the use of standard integrated circuits that would typically be unable to drive a large area display at the appropriate refresh rate. Alternate arrangements and numbers of pad segments 202 may be used to form a sectioned screen 104 that is appropriate for the direct drive scheme of embodiments discussed herein.

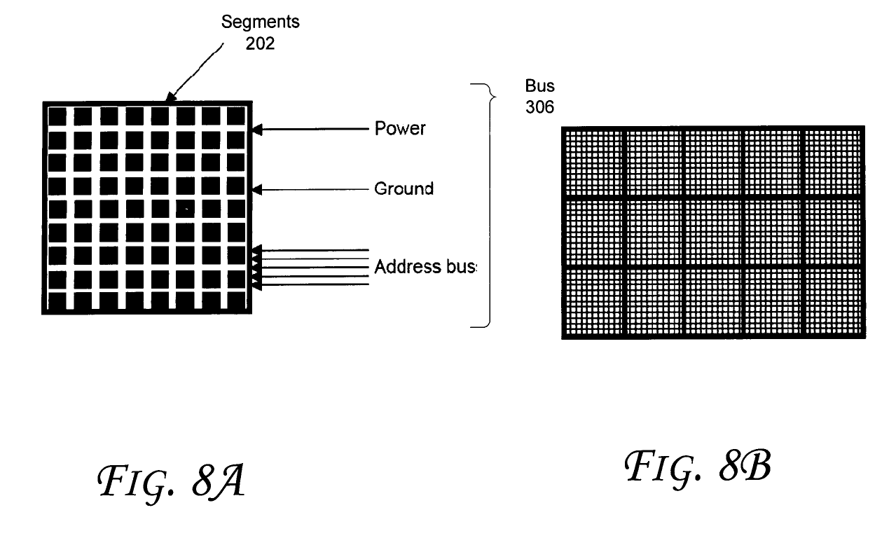

Further, multiple screen modules (e.g., such as that shown in FIG. 8A) may be coupled together to form a relatively large display surface (e.g., such as that shown in FIG. 8B that is formed by a grid of 5×3 of the modules shown in FIG. 8A) by using bus 306 (including power, ground, and address information, e.g., provided through a bus) to couple multiple back substrates 120, each having its own microcontroller 304 and an associated plurality of pad segments 202. For example, 15 screen modules such as screen 104 (or the configuration shown in FIG. 8A) may be coupled to form a large display (FIG. 8B) with the appropriate configuration of bus 306. Hence, individual back substrates 120 may be coupled together, with the electrical connections made between the front substrate 112 and the encapsulate layer 122 of FIG. 1.

In one embodiment, the sectioned screen 104 and back substrate 120 may enable a relatively high level of production throughput and yield. The direct drive to pad segments 202 allows the active layer 116 to respond at relatively low voltage levels while achieving the desired refresh rate and reducing the electromagnetic interference common to higher drive voltage schemes. Utilizing a continuous layer 116 across the plurality of pad segments 202 further reduces visibility of seams between the electrodes (118) that form pad segments 202 to an unaided human eye.

Further, the direct drive scheme may enable the microcontroller 304 to achieve desirable levels of uniformity of the image displayed on screen 104 by characterizing and compensating for differences between the pad segments 202 that form screen 104. By characterizing the performance of each pad segment 202, such as by sensing resistance or capacitance values, microcontroller 304 may modify the rate at which any particular pad segment 202 is driven, e.g., to force each pad segment 202 to appear optically similar to the other pad segments, as viewed by an unaided human eye.

In one embodiment, the embodiments of FIGS. 1-6 may include one or more processor(s) (e.g., microprocessors, controllers, microcontrollers, etc.) such as the microcontroller 304 of FIG. 3 to process various instructions to control the operation of the screen (104), the projector (102), and/or the projection system controller (106). These embodiments may also include a memory (such as read-only memory (ROM) and/or random-access memory (RAM)), a disk drive, a floppy disk drive, and a compact disk read-only memory (CD-ROM) and/or digital video disk (DVD) drive, which may provide data storage mechanisms the processors.

One or more application program(s) and an operating system may also be utilized which may be stored in non-volatile memory and executed on the processor(s) discussed above to provide a runtime environment in which the application program(s) may run or execute.

Some embodiments discussed herein (such as those discussed with reference to FIGS. 1-7) may include various operations. These operations may be performed by hardware components or may be embodied in machine-executable instructions, which may be in turn utilized to cause a general-purpose or special-purpose processor, microcontrollers (304), or logic circuit(s) programmed with the instructions to perform the operations. Alternatively, the operations may be performed by a combination of hardware and software.

Moreover, some embodiments may be provided as computer program products, which may include a machine-readable or computer-readable medium having stored thereon instructions used to program a computer (or other electronic devices) to perform a process discussed herein. The machine-readable medium may include, but is not limited to, floppy diskettes, hard disk, optical disks, CD-ROMs, and magneto-optical disks, ROMS, RAMs, erasable programmable ROMs (EPROMs), electrically EPROMs (EEPROMs), magnetic or optical cards, flash memory, or other suitable types of media or machine-readable media suitable for storing electronic instructions and/or data. Moreover, data discussed herein may be stored in a single database, multiple databases, or otherwise in select forms (such as in a table). For example, various computer-readable media may be utilized to adjust the optical characteristics of the pad segments 202 that form the screen 104.

Additionally, some embodiments discussed herein may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method comprising:
applying signals to a plurality of elements forming an active area of a screen to change the active area from having a first value of an optical characteristic to having a second value of the optical characteristic by changing each of the plurality of elements from having the first value to having the second value in synchronization.

2. The method as recited in claim 1, wherein:
each of the plurality of the elements includes a different one of a plurality of segments; and
the applying the signals includes providing the signals to each of the plurality of the segments.

3. The method of claim 1, wherein the optical characteristic is one of a reflectivity or an absorbance.

4. The method of claim 1, further comprising patterning a plurality of segments on one or more layers that form the screen.

5. The method of claim 1, further comprising joining a plurality of segments included in the plurality of elements to form the screen.

6. The method of claim 5, further comprising replacing or repairing one or more of the plurality of segments.

7. The method of claim 1, wherein the applying the signals is performed by a plurality of microcontrollers.

8. An apparatus comprising:
a screen including a plurality of elements forming an active area of the screen; and
a controller configured to provide signals to each of the plurality of elements to change each of the plurality of elements from having a first value of an optical characteristic to having a second value of the optical characteristic in synchronization.

9. The apparatus of claim 8, wherein the screen is a rear projection screen or a front projection screen.

10. The apparatus of claim 8, wherein the optical characteristic is one of a reflectivity or an absorbance.

11. The apparatus of claim 8, further comprising one or more continuous layers.

12. The apparatus as recited in claim 8, wherein:
the controller includes a plurality of microcontrollers; and
each of the plurality of the elements includes a different one of a plurality of segments with individual of the plurality of the microcontrollers coupled to multiple ones of the segments.

13. The apparatus of claim 12, further comprising a plurality of traces to couple each of the plurality of segments to the plurality of microcontrollers.

14. The apparatus of claim 12, further comprising a plurality of vias to couple each of the plurality of segments to a corresponding trace from a plurality of traces.

15. The apparatus of claim 14, wherein:
the plurality of vias include a configuration to pass through a back substrate of the screen to couple the each of the plurality of segments to the corresponding trace.

16. The apparatus of claim 12, further comprising:
a plurality of resistive elements coupled with different ones of the plurality of resistive elements coupled between ones of the plurality of segments.

17. A computer-readable medium comprising:
stored instructions to apply signals to a plurality of elements forming an active area of a screen to change the active area from having a first value of an optical characteristic to having a second value of the optical characteristic by changing each of the plurality of elements from having the first value to having the second value in synchronization.

18. The computer-readable medium of claim 17, further comprising stored instructions to instruct a plurality of microcontrollers to modify the optical characteristic of the screen.

19. The computer-readable medium of claim 17, further comprising stored instructions to coordinate one or more operations of the screen.

20. A system comprising:
a screen including a plurality of means for changing a reflectivity or an absorbance; and
means for controlling the plurality of the means for changing the reflectivity or the absorbance to change the reflectivity or the absorbance from having a first value of an optical characteristic to having a second value of the optical characteristic in synchronization to change the active area from having the first value to having the second value.

21. The system of claim 20, wherein the optical characteristic is one of a reflectivity or an absorbance.

22. The system of claim 20, wherein the means for controlling comprises one or more microcontrollers.

23. The system of claim 22, further comprising means for coupling each of the means for changing reflectivity or absorbance to the one or more microcontrollers.

24. The system of claim 20, further comprising means for coordinating one or more operations of the screen.

25. An apparatus comprising:
a screen comprising a plurality of elements forming an active area of the screen;
one or more microcontrollers to provide signals to each of the plurality of elements to change an optical characteristic of each of the plurality of elements; and
a plurality of vias to couple the one or more microcontrollers to one or more of the plurality of elements.

26. The apparatus of claim 25, further comprising a plurality of traces to couple the one or more microcontrollers to the plurality of vias.

27. The apparatus of claim 25, wherein the screen comprises a back substrate, wherein the plurality of vias provide an electrical connection through the back substrate.

28. The apparatus of claim 25, wherein the optical characteristic is one of a reflectivity or an absorbance.

29. The apparatus of claim 25, further comprising one or more continuous layers.
